(19) United States
(12) Patent Application Publication
(10) Pub. No.: US 2005/0213906 A1
(43) Pub. Date: Sep. 29, 2005

(54) Optical transmission mediums, and processes and apparatus for producing optical transmission mediums

(76) Inventors: Tohru Ogura, Shizuoka (JP); Takahito Miyoshi, Shizuoka (JP); Yukio Shirokura, Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/514,464

(22) PCT Filed: May 16, 2003
(86) PCT No.: PCT/JP03/06118

§ 371 Date: Jun. 7, 2005

(30) Foreign Application Priority Data
May 17, 2002 (JP) 2002-143113
May 17, 2002 (JP) 2002-143114
Apr. 1, 2003 (JP) 2003-098177

(51) Int. Cl. G02B 6/02

(52) U.S. Cl. 385/123

(57) ABSTRACT

A novel process for producing an optical transmission medium comprising a drawing step of drawing a molten portion of a preform to form the optical transmission medium is disclosed. In the process, the preform is heated by irradiation with laser light thereby being partially molten, and desirably rotated in a fixed direction, during the drawing step. An apparatus comprising a means for heating and melting partially a preform by irradiation with laser light and a means for drawing a molten portion of the preform is also disclosed. A novel plastic optical transmission medium is formed of a plastic wherein molecules are oriented in a certain direction not in parallel to the longitudinal direction of said medium is also disclosed.

### FIELD OF THE INVENTION

The present invention relates to processes for producing optical transmission mediums and apparatuses for producing the same, and in particular to producing processes and apparatuses preferably used for preparation of plastic optical transmission mediums. The present invention also relates to a plastic optical transmission medium having excellent mechanical properties.

### RELATED ART

In recent years, plastic based optical transmission mediums have been brought to attention in place of the previous silica based optical transmission mediums. Plastic based optical transmission mediums are widely used for various applications including optical fibers and optical lenses, by virtue of its advantages such that allowing more simple producing and processing at a lower cost as compared with silica based having the same structure. The plastic optical fiber is slightly inferior to silica-base fiber since the entire region of the element fiber thereof is made of plastic material and has, as a consequence, a little larger transmission loss, but superior to the silica based optical fiber in that having an excellent flexibility, lightweight property, workability, better applicability in producing a large bore diameter fiber and in producing with a lower cost. The plastic optical fiber is thus studied as a transmission medium for optical communication which is effected over a distance relatively as short as allowing such large transmission loss to be ignored.

A plastic optical fiber generally has a center core (referred to as “core region” in the specification) made of an organic compound and comprises a polymer matrix, and an outer shell (referred to as “clad region” in the specification) made of an organic compound having a refractive index differing from (generally lower than) that of the core region. There have been provided various processes for preparing the plastic optical fiber such as a directly spinning method, a extrusion-drawing method or a method comprising preparing a preform and drawing the mother material. In particular, the plastic optical fiber having a distributed refractive index along the direction from the center to the outside thereof recently attracts a good deal of attention as an optical fiber which can ensure a high transmission capacity.

One of conventionally known methods of producing a plastic optical fiber relates to a process in which a preform of an optical fiber is produced and then the preform is drawn. For example, one of the known methods for preparing graded-index fibers having excellent optical transmission properties, comprises preparing preforms thereof by an interfacial sol-gel process. The preform is generally drawn while being heated in a cylindrical heating furnace having an inner space thereof heated by an electric heater or the like. For example, the preform is hung at the upper end thereof, and is slowly brought down through the heating furnace to thereby allow the preform to melt. The preform is heated so as to be softened enough to allow fiber spinning, and the melted portion at the lower end of the preform is then drawn downward and is allowed to pass between pulling rolls. Continuous drawing is thus conducted.

In the conventional cylindrical heating furnace, the preform shows a rapid temperature rise for the surface thereof, but shows only a slower temperature rise for the inner portion thereof due to low heat conductivity of the plastic material. To raise the temperature of the entire portion of the preform to as high enough to allow the drawing, the preform therefore must stay in the furnace for a long time. Therefore, the preform is received needlessly the heat history in the heating furnace, thereby causing thermal degradation such as decomposition of the resin. Thus the optical properties of the obtained fibers degrade.

On the other hand, in order to improve the productivity, it is necessary to make drawing speed faster. To make drawing speed faster, however, shortens the residence time of the preform in the heating furnace, so that the preform reaches the drawing zone of the heating furnace while leaving the center portion thereof insufficiently heated and melted, and a trouble of drawing failure tends to occur. More specifically, insufficient heating and melting of the center portion of the preform undesirably increases drawing tension, and the resultant fiber becomes large in the diameter, hard to bend, and insufficient in the degree of drawing. This may cause troubles such as failure of a tension gauge and damage of pulling rolls. Moreover, an excessive tension exerted on a preform hanger may cause troubles of fracture of various components such as a preform folder, universal joint, center adjustor and the like.

In one known method for increasing the drawing speed while preventing failure in drawing, a plurality of heating furnace units are stacked to thereby increase the residence time of the preform, and thus allow the preform to thoroughly be heated to the center portion thereof. Faster pulling speed aiming at raising the productivity, however, inevitably increases the height of the heating furnace, makes it difficult to uniformly draw the entire length of the preform having a limited length, and increases loss to thereby lower the production efficiency against the expectation. Another problem of elongation of the heating zone of the preform typically by stacking a plurality of the heating furnace units resides in that a range of the preform possibly heated to as high as the melting point thereof or above becomes excessively long, and drawing of the preform can start within the heating furnace over a wide range thereof. In this case, even a minimal non-uniformity in the temperature or fluctuation in the heating furnace can vary and destabilize the starting position of drawing, and the upward or downward shift of the starting position of drawing inhibits stable drawing.

Another problem resides in that diameter of the preform gradually reduces in the direction from the position where the drawing starts towards the position where the drawing ends, and that the fiber can be taken up faster as the diameter of the preform becomes smaller. Therefore, unless the fiber is rapidly cooled after a predetermined fiber diameter is attained, the fiber may contact with conveying components such as pulling rolls while being kept in a softened state, and this causes torsion or skew of the fiber. In the conventional heating furnace, the drawn fiber could not efficiently be cooled due to heat conducted or radiated from a heating zone, and this sometimes increased transmission loss mainly ascribable to structural nonconformities such as mismatching at the core-clad interface, variation in the core diameter and micro-bending.

Adjustment of the tensile force during the drawing is also an important factor in fabrication of the plastic optical fiber. For example, too small tensile force can considerably weaken the obtained optical fiber, and even handling under a low tension during laying or the like may readily break it. On the contrary, too large tensile force may raise the tensile strength of the drawn fiber in the longitudinal direction thereof, but may embrittle the fiber against bending (may lower the knot strength), and this also raises practical problems. While the molecules can be oriented by the drawing, such molecular orientation undesirably increases coefficient of heat shrinkage, allows local shrinkage of the fiber depending on environmental changes, and consequently degrades the optical characteristics of the optical fiber. It is therefore strongly demanded to provide a plastic optical fiber having a desirable strength not only in the longitudinal direction but also in the transverse direction thereof, and being not causative of ruining of the optical characteristics due to non-uniform elongation and shrinkage.

It should further be noted that the tensile force during conventional drawing of the preform is mainly effected by adjusting temperature of the heating furnace, but it is practically difficult to control the tensile force during the drawing through temperature adjustment of the heating furnace, and stable preparation of the plastic optical fiber having the foregoing characteristics has not been realized yet. The conventional process also suffers from a problem that diameter of the fiber cannot be stabilized due to fluctuation of the starting point of the drawing within the furnace, and due to non-uniform melting status of the preform in the radial direction.

### SUMMARY OF THE INVENTION

An object of the present invention is to provide a process and an apparatus capable of producing optical transmission mediums having desirable properties in a stable and highly-productive manner.

Another object of the present invention is to provide plastic optical transmission mediums having a high strength, excellent handling property during laying down and the like, and relaxed anisotropy of the stretching property, and a process and an apparatus for producing such plastic optical transmission mediums. Still another object of the present invention is to provide a process capable of reducing variation in the diameter of the obtained fibers, and ensuring excellent producing stability, and an apparatus used therefore.

In one aspect, the present invention provides a process for producing an optical transmission medium comprising a drawing step of drawing a molten portion of a preform of the optical transmission medium to form the optical transmission medium, wherein, during the drawing step, the preform is heated by irradiation with laser light thereby being partially molten.

According to the above-mentioned embodiment of the present invention, a preform is heated by irradiation with laser light thereby being partially molten, and the molten portion is drawn. Since the laser irradiation not only selectively heats the preform in an extremely limited area, but also heats deep inside of the preform in an instantaneous and powerful manner, it is possible to prevent drawing failure even under high-speed drawing conditions. Heat history received by the preform can be reduced as compared with when the preform is heated in the conventional heating furnace, and this is advantageous in stably producing the optical transmission medium having desirable characteristics. Although the conventional process suffered from insufficient cooling of the optical transmission medium due to heat conduction typically from the heating furnace, the heating furnace is omissible or down-sizable in the present embodiment, and this successfully solves the problem of transmission loss of the optical fiber caused by insufficient cooling.

Output of laser light can be controlled more easily than temperature control of the conventional heating furnace, does not cause any heat transfer through convection, radiation or the like which are observable in the heating furnace, and can ensure a fairly rapid response to the temperature control by virtue of a narrow irradiation area. Adjustment of the diameter of the optical transmission medium by controlling output of the laser light ensures stable preparation of the optical transmission medium having a uniform diameter.

As embodiments of the present invention, there provided the process wherein said preform is formed of a plastic, and said laser light has a wavelength of 0.7 to 20.0 micrometers; the process wherein in the drawing step, at least output of the laser light is controlled to thereby adjust the diameter of the optical transmission medium; the process wherein irradiation energy efficiency of the laser light is 1% or above; the process wherein the laser is a carbon dioxide gas laser; the process, wherein, in the drawing step, the diameter DL of the area irradiated by said laser light satisfies the relational formula (1) below:
DL≦2.5×DP (1)
where, DP (mm) is the outermost diameter of a section in a plane normal to the longitudinal direction of said preform; the process wherein, in said drawing step, said laser light is irradiated from two or more directions differing from each other to said preform; the process further comprising before said drawing step, a preheating step of preheating said preform using a heat source other than the laser heat source to a temperature lower than the glass transition point thereof; the process wherein said preform has a distribution in the refractive index; and the process wherein said laser light is a pulsed laser light.

As one embodiment of the present invention, the process wherein the preform is rotated in a fixed direction during the drawing step is provided.

According to the above-mentioned embodiment, a preform is drawn under heating while being rotated in a fixed direction to thereby obtain an optical transmission medium. The preform is acted on by rotation during the drawing under heating, and orientation of the molecules is determined by a sum of a vector of drawing and a vector of rotation. The molecules in the transmission medium are oriented as being inclined by a predetermined angle away from the longitudinal direction of the transmission medium, and such inclined orientation of the molecules contributes to improvement in strength in the lateral direction normal to the longitudinal direction, and reduction in anisotropy of the stretching property. Drawing under rotation can also reduce non-uniformities in the structure and in diameter due to displacement of the drawing axis, and can raise the production stability.

As embodiments of the present invention, there are provided the process wherein said preform is rotated around an axis nearly in parallel to the axis of drawing; the process wherein a value of (Lᵣ/L_{d}) falls within a range from 0.01 to 95, where L_{d} represents a maximum displacement per unit time of an arbitrary point on the surface of said preform caused in the drawing direction produced by drawing under heating, and Lᵣ represents displacement per unit time thereof caused in the direction normal to said drawing direction produced by rotation; and the process wherein the angle of drawing falls within a range from 5° to 85°.

In another aspect, the present invention provides an apparatus for producing an optical transmission medium comprising a heating means for heating and melting partially a preform of the optical transmission medium by irradiation with laser light, and a drawing means for drawing a molten portion of the preform.

As embodiments of the present invention, there are provided the apparatus further comprising a control means for detecting the diameter of the drawn preform, and controlling at least output of said laser light based on the detected value; the apparatus wherein said heating means is a means for heating and melting partially said preform by irradiation with the laser light in an irradiation area having a diameter DL(mm) which satisfies the relational formula (1) below:
DL≦2.5×DP (1)
where, DP (mm) is the outermost diameter of a section in a plane normal to the longitudinal direction of said preform; the apparatus further comprising a preheating means for heating said preform to a temperature lower than the glass transition point thereof before said preform is heated and melted partially by said heating means; the apparatus wherein said preheating means is a means for heating said preform by allowing it to pass through a chamber conditioned at a temperature lower than the glass transition point of said preform; the apparatus wherein said heating means is capable of heating said preform at an energy efficiency of 1% or above; the apparatus wherein said drawing means is a means for drawing said preform into a fiber form by producing difference between a speed at which said preform is sent downward and a speed at which said preform is pulled downward; the apparatus wherein said drawing means is a means for drawing said preform into a fiber form by producing difference between a speed v₁ at which said preform is sent downward and a speed v₂ at which said preform is pulled downward, and said control means is a means for further controlling v₁ and/or v₂ based on said detected value; the apparatus further comprising a rotary support means for supporting said preform during drawing while keeping said preform rotated.

In another aspect, the present invention provides a plastic optical transmission medium formed of a plastic wherein molecules of the plastic are oriented in a certain direction not in parallel to the longitudinal direction of said plastic optical transmission medium.

Since the molecules in the plastic optical transmission medium of the present invention are uniformly oriented as being inclined by a predetermined angle away from the longitudinal direction of the transmission medium, the optical transmission medium has a large strength not only in the longitudinal direction but also in the lateral direction. Therefore, besides in the tensile strength in the longitudinal direction, the optical transmission medium is excellent in various properties such as knot strength, bending strength or the like, which are practically needed in the laying. And since the molecules are uniformly oriented as being inclined by a predetermined angle away from the longitudinal direction of the transmission medium, anisotropy ascribable to the molecular orientation is reduced, and the optical characteristics (optical loss, etc.) thereof are successfully prevented from being lowered due to non-uniform stretching.

As embodiments of the present invention, there are provided the plastic optical transmission medium wherein molecules of the plastic are spirally oriented around an axis which is nearly in parallel to the longitudinal direction of said plastic optical transmission medium; the plastic optical transmission medium wherein molecules of said plastic oriented as being inclined by 5° to 85° away from the longitudinal direction of said plastic optical transmission medium; the plastic optical transmission medium, having a shrinkage factor of 2% or less when measured in a weatherability test conducted at 70° C. and 40% RH for 48 hours; and the plastic optical transmission medium having a knot strength of 50 MPa or above.

### BRIEF DESCRIPTION OF THE DRAWINGS

FIG. 1 is a schematic sectional view of an exemplary producing apparatus used in one embodiment of the present invention.

FIGS. 2A and 2B are schematic views showing a preform under drawing.

FIGS. 3A and 3B are schematic views showing another embodiment of a plastic optical transmission medium of the present invention.

### DETAILED DESCRIPTION OF THE INVENTION

Some embodiments of the present invention will be described below, where they are only for the purpose of description and the present invention is not limited to these embodiments.

The processes of the present invention are applicable to processes of producing plastic optical fibers.

The first embodiment of the present invention will be described below referring to the attached drawings.

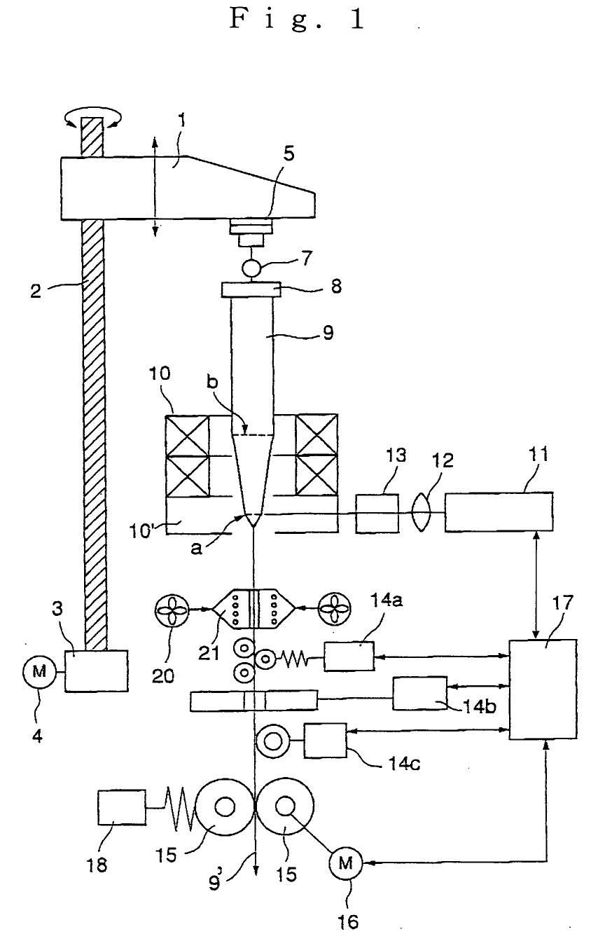

FIG. 1 is a schematic sectional view of a drawing apparatus applicable to one embodiment of a process of producing an optical transmission medium according to the present invention. The drawing apparatus shown in FIG. 1 is also one embodiment of an apparatus for producing an optical transmission medium according to the present invention.

The drawing apparatus shown in FIG. 1 comprises an arm 1 for supporting a rod-shaped preform 9, a laser generation means 11 for heating the preform 9, and a pair of pulling rolls 15 for drawing the preform 9 after softened under heating by laser irradiation using a laser generator 11. The arm 1 is attached to a screw 2 of a screw driver 3 driven by a motor 4, and is configured so as to ascend or descend. The arm 1 is also designed so as to shift the center axis of the preform 9 in the horizontal direction with the aid of an aligning device 5, to thereby correct displacement of the axis of drawing. On the end of the arm 1, a universal joint 7 and a preform holder 8 are attached so as to support the preform in a hanging style.

The laser light emitted from the laser generator 11 is collimated by a collimator 12, and intensity and irradiation pattern of which are then adjusted through an optical system including a zinc-selenium lens, mirror, etc. suited for carbon dioxide laser, and is then irradiated to the preform 9. A single set or two or more sets of the collimator 12 and the optical system 13 can be used as the occasion demands. It is more preferable to irradiate the preform 9 from two or more directions differing from each other because the preform 9 can more uniformly and rapidly be heated. It is also preferable to dispose a plurality of laser generators around the preform 9 and to irradiate the preform using the individual generators. It is still also preferable to divide a laser light from a laser generator using a mirror or the like so as to irradiate the preform 9 from a plurality of directions differing from each other. It is to be noted that for the case where the laser light is irradiated only from a single direction as shown in FIG. 1, use of a plurality of laser generators can more rapidly heat the preform.

The laser light irradiated to the preform 9 is absorbed by the preform 9, and heats the preform 9 in a rapid and uniform manner. To more efficiently irradiate the preform 9, it is preferable to adjust the diameter of the laser irradiation pattern slightly larger than the diameter of the preform. Such slightly larger adjustment of the laser irradiation area, however, allows a part of the laser light to directly reach the rear of the preform 9 without being absorbed by the preform 9. Also the laser light incident to the preform 9 can partially pass therethrough after being refracted in the preform, and again can reach the rear of the preform. It is therefore basically necessary to configure at least the wall surface, to which the laser light can be incident, using a material such as refractory brick or the like, and so as to prevent the inner components of the heat drawing apparatus from being fractured even when the wall surface is directly exposed to the laser light. For an exemplary case shown in FIG. 1, it is preferable to dispose refractory bricks or the like on the inner wall of a cylindrical chamber 10′ in which the preform is irradiated.

For the exemplary case where a plurality of laser generators are disposed around the preform 9 and the preform 9 is irradiated by the individual laser generators, opposed arrangement of any of these generators while placing the preform 9 in between may result in damages on one laser generator or an optical system thereof caused by laser light from the other laser generator. Therefore for the case where a plurality of laser generators are used to irradiate the preform 9, it is preferable to irradiate the laser light at a certain angle away from the longitudinal direction of the preform 9 so as not to irradiate the opposed laser generator with the laser light. More specifically, it is preferable to dispose the laser generators 11 so as to avoid positioning on the same plane. If the laser generators are disposed on the same plane, it is preferable to use an odd number of laser generators for the irradiation, or to use mirrors or the like in order to incline the light path by an angle. For the purpose of raising the irradiation efficiency of the laser light, it is also allowable to use mirrors or the like so as to direct the laser light once reached the rear of the preform back to the preform again. It is still also allowable to conduct multi-step laser irradiation in the longitudinal direction of the preform 9.

It is again preferable to irradiate the laser light while rotating the preform so that heat can more uniformly be applied to the preform. For example, by disposing a rotating device between the arm 1 and preform folder 8, and by rotating the preform 9 around the center axis (along the longitudinal direction) thereof, the laser light can more uniformly be irradiated along the circumference of the preform.

Output of the laser light irradiated to the preform 9 affects diameter of the fiber 9′. The laser light can, therefore, be used not only as a means for heating and melting the preform 9, but also as a means for controlling the diameter of the fiber 9′. For example, the diameter of the fiber 9′ is detected by a laser measuring gauge 14b on the way from a heater 10 to the pulling rolls 15, and output of the laser generator 11 is controlled so that a deviation of the detected value from a predetermined optimum value of the fiber diameter is reduced to zero. The output of the laser generator 11 can readily be controlled using a computer 17 as shown in FIG. 1. It is still also allowable to control the output of the laser generator 11 based not only on the diameter of the fiber 9′ but also on tensile force of the preform 9 obtained from a tension gauge 14a, and/or on a detected value obtained from a range counter 14c.

It is to be noted now that, as described later, the diameter of the fiber 9′ is adjustable by controlling the drawing force of the pulling rolls 15, but control of the laser output is more advantageous in view of leveling the optical characteristics. Reasons for this issue will be described later.

Laser generators industrially practiced include excimer laser, YAG laser and carbon dioxide gas laser by virtue of their large output. The laser generator 11 can be any of these laser generators, where any other types of laser generators also allowable basically provided that they can give energy sufficient for melting the preform in a concentrated manner. Since the preform 9 is composed of a plastic, it is preferable to use a long-wavelength laser adapted to stretching vibration modes of organic compounds, where the wavelength of which resides within a range from 0.7 to 20.0 micrometers. In particular, carbon dioxide gas laser is preferable since it can produce an output up to as high as 10 kW or around, capable of providing a sufficient energy to the preform 9, and since the applied energy can efficiently be converted into heat because the wavelength of the laser matches to stretching vibration mode of organic compounds. On the other hand, excimer laser is suitable for heating metal-based, ceramics-based or glass (excluding quartz)-based preforms, rather than for the present embodiment in which the preform is composed of a plastic, because the excimer laser can produce only a lower output, and main action thereof relates to cleavage of the molecules in the ultraviolet region. YAG laser can produce an output of as large as several kilowatts when a basic wave of 1.064 nm is used.

Pulsed laser is advantageous in that the output thereof can be stabilized more easily than that of continuous-wave laser, and is particularly preferable in view of more easily controlling heat energy during the heating. In the present embodiment in which the preform composed of a plastic is drawn, pulsed irradiation of carbon dioxide gas laser is more preferable.

The preform 9 is heated and melted by the laser light emitted from the laser generator 11, where it is also allowable to combine the laser generator 11 with a conventional heating furnace 10 using an electric heater as shown in FIG. 1. By using a plurality of heating appliances, the preform 9 can more efficiently be heated, and the appliance can be reduced in the size and cost thereof. The heating furnace 10 has a cylindrical shape, and is generally divided into two or more compartments vertically stacked, and the individual compartments are independently controlled for the temperatures. An annular orifice is placed at every interface of the compartments, and is kept 1 mm to 5 mm distant from the preform 9. Although the distance between the preform 9 and the orifice of less than 1 mm is not prohibited, the distance is preferably kept in the above range so as to avoid troubles taking variation in diameter of the preform and conformity with the aligning device 5 into consideration. The inner space of the individual compartments of the heater 10 is preferably controlled at a temperature not causative of promoting degradation of the preform 9, and for a typical case of polymer, it is preferable to generally control the temperature within a range (generally 40° C. to 120° C.) lower than T_{g} (glass transition point) of the polymer.

The fiber 9′ then passes through the inner space of a cooling chamber 21 disposed downstream of the heating furnace 10 and fed with a cool air supplied from a cooling fan 20, and is thus cooled. A smaller size of the heating furnace 10 is advantageous in avoiding inhibition of cooling of the fiber due to heat conduction from the heating furnace. This is preferable for reducing transmission loss of the fiber ascribable to insufficient cooling. In the present embodiment, heating and melting of the preform is carried out by the laser irradiation, so that there is no need to scale up the heating furnace 10. Or rather, down-sizing of the heating furnace 10 desirably reduces transmission loss of the fiber possibly caused by insufficient cooling.

A pair of pulling rolls 15 are designed to nip the preform 9 in the nipping portion and to draw it downward. One of the pulling rolls is driven by a pulling motor 16 by which the downward pulling force is adjustable. Another roll not driven by the motor is designed to be pressurized by a pressurizing device 18 against the motor-driven roll so as to follow rotation of the motor-driven roll. Downward pulling speed of the preform 9 can be controlled typically by the computer based on detected values obtained from the tension gauge 14a for detecting tensile force of the preform 9, a laser measuring gauge 14b for detecting diameter of the preform 9, and/or range counter 14c disposed on the way from the heater 10 to pulling rolls 15.

Diameter of the fiber is adjustable also by similarly controlling the descending speed of the preform 9 with the aid of the arm 1, together with, or instead of the pulling speed. According to the embodiment, the preform is drawn into a fiber form due to difference between a speed v₁ at which said preform is sent downward by the arm 1 and a speed v₂ at which said preform is pulled downward by the rolls 15. The diameter of the fiber is adjustable by controlling v₁ and/or v₂.

The following paragraphs will describe an outline of the drawing process using the above-described drawing apparatus.

The preform 9 is attached to the preform holder 8 of the arm 1, and is supported in a hanging style. When the screw driver 3 is driven, the screw 2 rotates at a constant speed, the arm 1 descends, and the preform 9 is inserted into the heater 10. The preform 9 is sequentially preheated by the individual compartments of the heater 10 up to a temperature below T_{g}. When the preform 9 descends further, it is then heated by irradiation with the laser light emitted from the laser generator 11, and melted end of the preform 9 is drawn by the pulling rolls 15 placed downstream of the heater 10, and thus drawn. The preform 9 is descended at a predetermined speed by the arm 1, and drawn by the pulling rolls 15 at a predetermined speed, where a difference between these speeds allows the preform 9 to be continuously drawn in a fiber form, to thereby produce the fiber 9′.

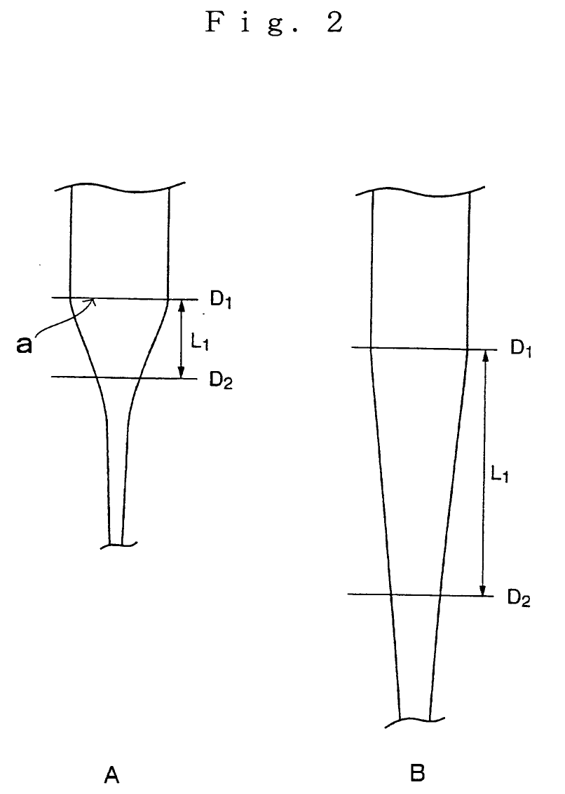

By using laser irradiation, the preform 9 is selectively and instantaneously heated deep inside with a large energy concentrated within a small area, and is uniformly and rapidly melted. FIG. 2A schematically shows a status of drawing the preform melted under heating by laser irradiation, and FIG. 2B schematically shows a status of drawing the preform melted under heating using a heating furnace. Since heat gradually reaches deep inside from the surface of the preform by the heating only using the heating furnace, it takes a relatively long time before the temperature allowing the drawing is reached, and troubles such as drawing failure may occur under an increased speed of drawing. This consequently demands to gradually reduce diameter of the preform as shown in FIG. 2B. To thoroughly heat the preform, it is necessary to use a large-sized heating furnace such that compartments are stacked to a considerable height, so as to allow the preform to be retained within the heating furnace for a longer time. Thus, the preform, however, will receive needlessly heat history, thereby occurring thermal degradation such as decomposition of the resin thereof and lowering the optical characteristics thereof. It is also necessary to rapidly cool the fiber after drawing, but the fiber could not efficiently be cooled due to heat conducted or radiated from the heating furnace, and this sometimes increases transmission loss mainly ascribable to structural defectives such as mismatching at the core-clad interface, variation in the core diameter and micro-bending. On the other hand, heating by the laser irradiation can heat the preform deep inside in a powerful manner, and even a heating within a small area can raise the temperature high enough for the drawing. Therefore the diameter of the preform can abruptly be reduced as shown in FIG. 2A, and the pulling speed can be raised. Even for the case where the heating furnace is used, it is no more necessary to enlarge the heating furnace, or rather the heating furnace can be down-sized to thereby reduce the influence by heat conduction, and thus can solve the problems possibly arise from the conventional heating furnace.

As illustrated in FIG. 2A, an advantage of the laser irradiation resides in that heating can be attained in a very narrow area in a powerful manner. A preferable condition of the heating can be determined using Eₚ defined by the equation (2) below as an index:
Eₚ=½×(D₁/L) (2)
where, D₁ represents the diameter of the preform at position (a) where the drawing starts, and L represents a distance between position (a) and a position where the diameter of the preform becomes ½×D₁ by drawing.

In the present embodiment, a value of Eₚ is preferably 0.25 or above, more preferably 0.3 or above, and still more preferably 0.5 or above, where the upper limit thereof is 1.5 when practically considering a relation between the pulling speed and heating area. On the other hand, for the case where the heating furnace is used as shown in FIG. 2B, Eₚ generally falls within a range from 0.10 to 0.23 or around.

In the drawing apparatus shown in FIG. 1, the preform 9 is heated by two kinds of heating means (heating furnace 10 and laser generator 11) disposed at different positions in the longitudinal direction (two positions of upper and lower ones in FIG. 1), so that the preform 9 has portions “a” and “b” where the diameters reduce at different rates of change. In this case, that is, for the case where the preform is heated by the multi-step heating in the longitudinal direction and consequently has a plurality of portions having diameters reducing at different rates of change, a portion showing the largest rate of change (position “a” in FIG. 1, and is generally a portion closest to the drawing component such as pulling rolls) is assumed as the drawing start position (position where D₁ is measured).

Too high maximum temperature of the preform possibly reached by the laser irradiation causes local decomposition and thermal degradation of the preform, and tends to inhibit uniform drawing in particular for the case where foaming could occur. On the other hand, also too low maximum temperature is not desirable in view of obtaining a desirable fiber because it raises tensile force during the drawing to thereby cause a strong molecular orientation, and thus tends to degrade properties such as bending performance.

Too large irradiation area in the laser irradiation is not desirable because the preform is irradiated over a wide range in the drawing axis thereof, and the drawing starts at multiple points in the preform so as to destabilize the drawing. Especially when a preform having a distributed refractive index is irradiated by the laser, it is more important to control the irradiation area since the preform may have a distributed Tg. Too large diameter of the irradiation area also causes laser light irradiation in a diffused status, and this is undesirable not only because the efficiency of irradiation is ruined due to inefficient irradiation of the preform, but also because the laser light not landed on the preform can damage the drawing furnace. Assuming now that DP (mm) represents the outermost diameter of a section of the preform taken along a plane normal to the longitudinal direction thereof, and DL (mm) represents the diameter of the irradiation area, the aforementioned tendency is successfully avoidable and the optical fiber can be produced with a more higher productivity when the relational formula (1) below is satisfied:
DL≦2.5×DP (1)

The preform can be melted even if the lower limit of DL falls below the diameter thereof when considering possible irradiation around the laser irradiation area, diameter of the preform, and heat conductivity of a material composing the preform. While the lower limit of the diameter of the irradiation area may vary depending on the aforementioned factors, a specific value thereof is considered as at least 0.7 times of DP or around. That is, DL preferably falls within a range from 0.7×DP to 2.5×DP, and more preferably from 1.2×DP to 1.5×DP.

It is to be noted that the diameter of irradiated area in this specification means a diameter at which an integral value of output distribution reaches 98% or the total. The diameter of the irradiated area is adjustable by altering a combination of defocus lenses. If the irradiated area in the laser irradiation has a circle form, the diameter of such irradiated area can be assumed as DL, whereas if it does not have a circle form (e.g., oval form), an average of the longest diameter and shortest diameter is assumed as DL. Similarly, the diameter of the preform is assumed as DP if the section of the preform has a circle form, whereas an average of the longest diameter and shortest diameter is assumed as DP if it does not have a circle form.

The larger the irradiation energy of the laser light irradiated to the preform is, the better. Irradiation energy efficiency is preferably 1% or above. The energy efficiency can be raised by properly selecting wavelength of the laser light depending on materials composing the preform. More specifically, for the case where the preform is composed of an organic material, it is preferable to use a long-wavelength laser adapted to stretching vibration modes of the organic compound since the applied energy can efficiently be used for heat generation. It is also allowable to improve the energy efficiency by adjusting area of the laser irradiation.

It is to be noted that “energy efficiency” in this context means a ratio of energy used for raising temperature of the preform (an energy calculated based on specific heat and temperature rise of the preform) to the total irradiated energy.

The diameter of the fiber is preferably adjusted by controlling output of the laser light. By controlling output of the laser light, it is made possible to obtain the fiber showing excellent uniformities not only for the diameter thereof but also for the optical characteristics thereof. There is another process for controlling the diameter based on the pulling speed. For example, the diameter can be made uniform with a high accuracy by detecting the fiber diameter and by controlling the pulling speed so as to keep the detected value constant. The control of the pulling speed so as to keep the outer diameter constant, however, varies the drawing speed in a process by which the preform is drawn to produce the fiber having a predetermined outer diameter. When the preform is drawn at a high speed, the tensile force is increased and resin molecules composing the matrix of the preform are highly aligned in an orientation state. On the contrary, when the preform is drawn at a low speed, the tensile force is reduced as compared with above and the molecules are lowly aligned as compared with above. Such variation in the molecular orientation depending on difference in the drawing speed is also observed even for a material having a matrix resin less likely to be oriented and crystallized. This adversely affects mechanical strength of the fiber, and is undesirable in terms of uniformity of the fiber. Variation in the tensile force according to a short periodicity may cause interfacial non-conformities and may worsen the transmission loss or the like of the fiber.

If the diameter of the fiber is adjusted by controlling output of the laser light, pulling can be continued at a constant speed, and this successfully prevents the optical characteristics from becoming non-uniform. It is therefore possible to produce the fiber having a uniform diameter and uniform optical characteristics in an constant manner by controlling output of the laser light, or by combining the control of the laser output with any other control of producing conditions. For example, in order to adjust the diameter of the preform, it is possible to combine the control of the laser output with the control of v₁, at which said preform is sent downward by the arm 1, and/or v₂, at which said preform is pulled downward by the rolls 15.

The diameter of the obtained fiber is preferably within a range from 0.2 mm to 2.0 mm, while being not limited thereto. The diameter of the core portion is preferably within a range from 0.1 mm to 1.5 mm, while being not limited thereto.

Next the second embodiment of the process of producing an optical transmission medium of the present invention will be described below.

The second embodiment can be carried out using the apparatus shown in FIG. 1 except that an arm which has a rotating device between itself and the preform folder 8 and is configured so that drawing can be carried out while rotating the preform 9 around the center axis thereof (center axis along the longitudinal direction) is used in the place of the aim 1.

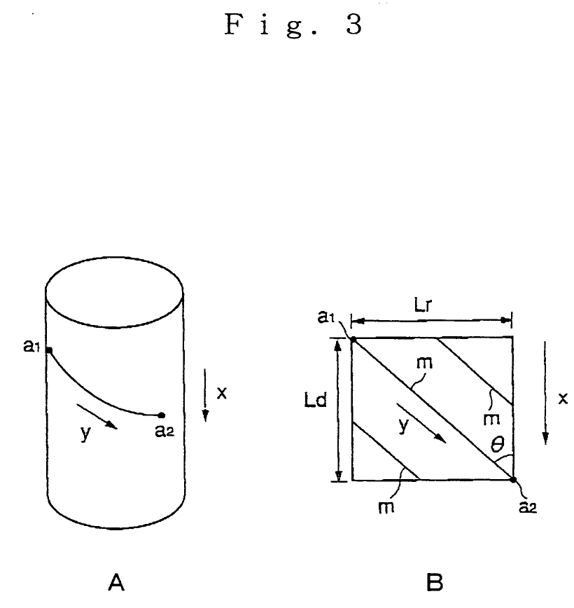

According to the embodiment, the preform 9 is drawn in the longitudinal direction while being rotated at a constant speed by the rotating device. As schematically shown in FIG. 3A, an arbitrary point a₁ on the circumferential surface of the preform 9 moves to point a₂ within a unit time during the drawing. This can be expressed by a molecular status in which the molecules are spirally oriented along the a₁-a₂ direction around a spiral axis in parallel to the longitudinal direction of the preform. Displacement of an arbitrary point on the preform 9 is expressed in a developed chart of the surface in FIG. 3B. Defining now the diameter of the preform 9 as R (m), speed of rotation as Vᵣ (rotations/sec) and drawing speed as V_{d} (m/sec), the arbitrary point a₁ shifts by Lᵣ=nR×Vᵣ per unit time in the circumferential direction (horizontal direction in the drawing) by the contribution of the (counter-clockwise) rotation, and shifts by L_{d}=V_{d} in the longitudinal direction by the contribution of the pulling, to thereby reach point a₂. In an expression of this in a molecular status, the molecules are uniformly oriented in the direction (a₁-a₂) inclined by angle θ away from the longitudinal direction.

The diameter of the preform is defined as an average of measured values of outer dimension thereof obtained at three arbitrary points.

By this drawing process, the plastic optical fiber is readily obtained in a form in which the molecules thereof are spirally oriented around a spiral axis in parallel to the longitudinal direction of the fiber. It is also possible to adjust θ within a desired range by properly combining the speed of rotation Vᵣ and drawing speed V_{d}. To constantly obtain the plastic optical fiber having the molecules thereof oriented in a predetermined direction, it is preferable to adjust a ratio (Lᵣ/L_{d}) of displacement Lᵣ per unit time in the circumferential direction contributed by the rotation and displacement L_{d} in the longitudinal direction contributed by the pulling within a range from 0.01 to 95. Adjustment of Lᵣ/L_{d} in this range facilitates preparation of the plastic optical fiber having the molecules thereof oriented at an angle of 50 to 85° away from the axis of drawing. The drawing under rotation is also beneficial in stabilizing the diameter of the resultant fiber, and thus in improving the production stability.

The specific effect brought about by rotation during drawing may be also obtained when the preform is heated by heating apparatus other than a laser, for example a heating furnace.

One embodiment of the plastic optical transmission medium produced by the producing process according to the present embodiment relates to a plastic optical fiber having a core portion and a cladding potion, both comprising a polymer, in which molecules of the polymer composing the core portion and cladding portion are spirally oriented around a spiral axis which is nearly in parallel to the longitudinal direction of the fiber. Schematic drawings of the plastic optical fiber of the present embodiment are shown in FIGS. 3A and 3B. Arrow “x” indicates the longitudinal direction of the plastic optical fiber, and arrow “y” indicates the direction of molecular orientation. As shown in FIG. 3A, the plastic optical fiber of the present embodiment has the molecules thereof spirally oriented in the direction indicated by arrow “y” around a spiral axis in parallel to the direction indicated by arrow “x”. This is further expressed by a developed chart of a portion of the surface as shown in FIG. 3B, in which the individual polymer molecules are oriented in the direction of arrow “y” inclined by an angle E (0°<θ<90°, preferably 5°≦θ≦85°, and more preferably 30°≦θ≦84°) away from the direction of arrow “x” (longitudinal direction).

Molecular orientation affects various characteristics such as strength and stretching directionality. The strength is generally large in the direction of orientation but small in the direction normal thereto. In an embodiment where the molecules are oriented only in parallel to the drawing direction, bending force applied to the fiber generates shearing force in the direction normal to the drawing direction, and the fiber is more likely to break than in the case where the force is applied in the direction of orientation. On the contrary, the plastic optical fiber of the present embodiment having the molecules thereof spirally oriented exhibits a large strength not only against the force applied from the drawing direction (longitudinal direction in the present embodiment) but also against the force applied from the direction inclined away from the drawing direction. The fiber is thus excellent not only in the tensile strength in the longitudinal direction, but also in various strengths practically needed in the laying or the like, such as knot strength and bending strength. The molecular orientation also enhances stretching property in the orientation direction, that is, produces anisotropy in the stretching property. In an embodiment where the molecules are oriented only in parallel to the drawing direction, the fiber stretches only in the drawing direction (longitudinal direction in the present embodiment) depending on environmental factors such as temperature and humidity during the storage, and these results in degraded optical characteristics. On the contrary, the plastic optical fiber of the present embodiment is formed of the molecules spirally oriented, so as that the anisotropy in the stretching property is relaxed, and partial stretching in a predetermined direction is reduced.

The plastic optical fiber of the present embodiment preferably has a tensile strength in the longitudinal direction of 70 MPa or above, more preferably 90 MPa or above, and still more preferably 150 MPa or above. The tensile strength in the longitudinal direction can be measured according to JIS C6861-1999. The test environment is expressed as standard conditions specified in JIS C0010 (temperature: 15° C. to 35° C., relative humidity: 25% to 85%, atmospheric pressure: 86 kPa to 106 kPa). An exemplary available test instrument can be “Tensilon Universal Tester” produced by Orientec Corporation.

The plastic optical fiber of the present embodiment preferably has a knot strength of 50 MPa or above, more preferably 60 MPa or above, and still more preferably 70 MPa. While a larger knot strength is more preferable, a general limit falls on 40 MPa or below. The knot strength can be determined by making a knot in the fiber and by measuring tensile strength of such fiber in the longitudinal direction.

The plastic optical fiber of the present embodiment preferably has a shrinkage factor in the longitudinal direction of 2% or below when measured in a weatherability test conducted at 70° C. and 40% RH for 48 hours, more preferably 1% or below, and still more preferably 0.5% or below. The smaller the shrinkage factor is, the better. Any materials having molecular orientation, however, cause a certain degree of shrinkage, and the factor generally falls within a range from 2 to 5% or above. It is to be noted now that, in this specification, “weatherability test” means a test in which a plastic optical fiber of 1 m long is allowed to stand without being applied with tension in a weatherability test chamber conditioned at 70° C. and 40% RH.

According to the present invention, optical transmission mediums are produced by drawing preforms which are produced according to various known processes such as a melt extrusion method or a bulk polymerization method. The preform is desirably produced according to a bulk polymerization method since the preform having excellent properties can be produced easily and stably. Next, a method for producing a preform comprising bulk polymerization method will be described in detail, however, the present invention is not limited this.

The preform can be produced according to a bulk polymerization method, more specifically interfacial-gel polymerization method. One method for preparing the preform using a bulk polymerization method, comprises a first step of producing a hollow structure (for example a cylinder) corresponding to a clad region; and a second step of producing a preform which comprises areas respectively corresponding to a core region and the clad region by carrying out polymerization of a polymerizable composition in the hollow portion of the structure.

In the first step, a hollow structure (for example cylinder) made of a polymer is obtained. As typically described in International Patent Publication WO93/08488, a polymerizable monomer is put into a cylindrical polymerization vessel, and then polymerization is carried out while rotating (preferably while keeping the axis of the cylinder horizontally) the vessel (a polymerization carried out while rotating a vessel referred as “rotational polymerization” herein after) to thereby form a cylinder made of a polymer. Another material such as a polymerization initiator, a chain transfer agent and a stabilizer may be added to the monomer. The desirable additional amounts of the polymerization initiator and the chain transfer may be various according to what a kind used, however, in general, the desirable additional amount of the polymerization initiator may be in a range of 0.01 to 1.00 wt %, more desirably in a range of 0.40 to 0.60 wt %, of the monomer; and the desirable additional amount of the chain transfer agent may be in a range of 0.10 to 0.40 wt %, more desirably in a range of 0.15 to 0.30 wt %, of the monomer. Polymerization temperature and polymerization time may be decided in consideration of the monomer to be employed. In general, the polymerization is preferably carried out at 60 to 90° C. for 5 to 24 hours.

The clad region has a refractive index desirably lower than that of the core region in order to confine light to be transmitted within the core region. The clad region has desirably transparency for transmitted light. Examples of the monomer for the clad region include methyl methacrylate (MMA), deuterated methyl methacrylate (e.g. MMA-d8, d5 and d3), fluorinated alkyl methacrylate (e.g. trifluoroethyl methacrylate (3FMA), hexafluoroisopropyl-2-fluoroacrylate (HFIP 2-FA), diethyleneglycol bisallylcarbonate. The clad region may be formed of a copolymer of two or more monomers above. A major component of the polymerizable monomer used for producing the clad region is preferably identical with that of the polymerizable monomer used for producing the core region, from the viewpoint of transparency. Examples of the polymers constituting the clad region include polymethyl methacrylates, polystyrenes, polycarbonates, methyl methacrylate-styrene copolymers, α-methylstyrene-methyl methacrylate copolymers, fluorinated alkyl methacrylate-tetrafluoroethylene copolymers, perfluoroallylvinylether polymers, fluorinated-deuterated-polymers and duterated polymethyl methacrylates.

One or more polymerization initiators and polymerizarion controllers such as chain transfer agents may be added to the monomers. The polymerization initiator can properly be selected in consideration of the monomer to be employed. Possible examples thereof include peroxides such as benzoyl peroxide (BPO), t-butylperoxy-2-ethylhexanate (PBO), di-t-butylperoxide (PBD), t-butylperoxyisopropylcarbonate (PBI), and n-butyl-4,4-bis(t-butylperoxy)valerate (PHV); and azo compounds such as 2,2′-azobisisobutylonitrile, 2,2′-azobis(2-methylbutylonitrile), 1,1′-azobis(cyclohexane-1-carbonytrilie). The polymerization initiators can be classified according to usable temperature range; a first group of polymerization initiators, which may be used at a comparatively high temperature, specifically not lower than 80 degrees Celsius, consisting of cumene hydroperoxide, tert-butylperoxide, dicumylperoxide, and di-tert-butylperoxide; a second group, which may be used at a middle temperature, specifically from about 40 to about 80 degrees Celsius, consisting of benzoyl peroxide, lauroyl peroxide, potassium persulfate, ammonium persulfate and azobisisobutylyl, and a third group, which may be used at a comparatively low temperature, specifically from about −10 to about 40 degrees Celsius, consisting of hydrogen peroxide-ferrous salt, persulfate salt-acidic sodium sulfite cumene hydro peroxide-ferrous salt, benzoyl peroxide-dimethyl aniline. The initiators which may be used at not lower than room temperature can be used, among them benzoyl peroxide and azobisisobutylnitrile are preferred. The combinations of peroxides—organic alkyl metals and of oxygen's-organic alkyl metals may also be used for initiating polymerization.

Polymerization controllers are generally used mainly for adjusting molecular weight of polymers and can properly be selected in consideration of the monomer to be employed. Among them, chain transfer agents are preferred. Chain transfer agents are generally used mainly for reducing ununiformity and variation in physical properties of polymers and for controlling molecular weights of polymers. The chain transfer agent can properly be selected in consideration of the monomer to be employed. The examples include alkylmercaptans (n-butylmercaptan, n-pentylmercaptan, n-octylmercaptan, n-dodecylmercaptan, t-dodecylmercaptan, etc.), thiophenols (thiophenol, m-bromothiophenol, p-bromothiophenol, m-toluenethiol, p-toluenethiol, etc.)., thioglycollic acids and diisopropyoxanethogen. Preferable species are alkylmercaptan such as n-octylmercaptan, n-dodecylmercaptan, t-dodecylmercaptan, butylmercaptan or amylmercaptan t-dodecylmercaptan. It is allowable to use tow or more species of the chain transfer agents. It is also allowable to use the known chain transfer agent such as aliphatic mercaptans or dipropyoxyanethogen, however, butylmercaptan and amylmercaptan are preferred, and butylmercaptan is more preferred from the viewpoint of odors thereof.

Another possible strategy relates to addition of other additives to the clad region to an extent not degrading the light transmission property. For example, an additive can be added in order to improve the weatherability or durability. It is also allowable to add an emission inductive material for amplifying light signal for the purpose of improving the light transmission property. Since even attenuated light signal can be amplified by addition of such compound to thereby elongate the length of transmission, the compound is typically applicable to produce a fiber amplifier at a part of light transmission link.

These additives may be added to the core region.

The cylinder corresponding to the clad region preferably has a bottom portion, so as that a material for the core region can be poured into the cylinder in the second step. The preferred material for the bottom portion is a material having a good affinity and adhesiveness with the polymer of the cylinder. The bottom portion may be formed of the same polymer as that of the cylinder. For example, the bottom potion can be produced by pouring a small amount of monomer into a vessel before or after carrying out rotational polymerization; and carrying out polymerization of the monomer with still standing the vessel.

A step for producing an outer core layer, which is made of a polymer having a high affinity for the polymer constituting the core region, on the inner surface of the clad region can be carried out after such rotational polymerization, so as to facilitate the polymerization for the clad region in the second step. For the purpose of completely reaction of the residual monomer or the residual polymerization initiator, it is also allowable after such rotational polymerization to carry out annealing at a temperature higher than the polymerization temperature, or to remove non-polymerized components.

The monomer used herein may be pre-polymerized before the polymerization so as to raise the viscosity thereof as described in JP-A No. hei 8-110419. Since the obtained hollow structure may be deformative when the vessel may get distorted by rotation, it is preferable to use a metal or glass vessel having a sufficient rigidity.

In the first step, it is also possible to produce the structure having a desired shape (cylindrical shape in this embodiment) by molding polymer using known molding technique such as extrusion molding.

In the second step, a polymerizable monomer is poured into the hollow portion of the cylinder, which was obtained by the first step, corresponding to the clad region, and the polymerization of the monomer is carried out under heating. One ore more polymerization initiators, chain transfer agents and if necessary, agents for adjusting refractive index may be added to the monomer. The desirable additional amounts of them may be various according to what a kind used, however, in general, the desirable additional amount of the polymerization initiator may be in a range of 0.005 to 0.050 wt %, more desirably in a range of 0.010 to 0.020 wt %, of the monomer; and the desirable additional amount of the chain transfer agent may be in a range of 0.10 to 0.40 wt %, more desirably in a range of 0.15 to 0.30 wt %, of the monomer. It is also possible to build up the refractive index distribution structure in the core region by using two or more monomers without using the agent for adjusting refractive index.

In the second step, the polymerization of the monomer as the source material, which is poured into the hollow portion of the cylinder, is carried out. From the view point of residues after polymerization, it is preferred to carry out the polymerization by a method based on the interfacial gel polymerization process which is solvent-free, disclosed in International Patent Publication No. WO93/08488. In the interfacial gel polymerization process, the polymerization of the polymerizable monomer proceeds along the radial direction of the cylinder from the inner wall thereof, of which viscosity is high, towards the center due to gel effect.

For the case where two or more polymerizable monomers are used, the monomers have different degrees of polymerization ability due to differential affinity to the polymer of the cylinder and differential diffusion (because of differences of intrinsic volumes and solubility parameters of the monomers) in a gel. Thus the monomer having a higher affinity to the polymer of which the cylinder is made predominantly segregates on the inner wall of the cylinder and then polymerizes, so as to produce a polymer having a higher content of such monomer. Ratio of the high-affinity monomer in the resultant polymer reduces towards the center. Thus, the distribution of refractive index can be created along the interface with the clad region to the center of the core region.

When the polymerizable monomer added with a refractive index adjusting agent is used in the polymerization, the polymerization proceeds in a way such that the monomer having a higher affinity to the polymer, of which the cylinder is made predominantly, exists in larger ratio on the inner wall of the cylinder and then polymerizes, so as to produce on the outer periphery a polymer having a lower content of the refractive index adjusting agent. Ratio of the refractive index adjusting agent in the resultant polymer increases towards the center. This successfully creates the distribution of refractive index adjusting agent and thus introduces the distribution of refractive index within the area corresponding to the core region.

Source materials for the core region are not limited so far as the polymers thereof have a transparency for transmitting light, however, the materials which have a low transmission light loss are preferred. The preferred examples of the monomer for the core region include (meth)acrylic esters, which include (a) Non-fluorine-containing (meth)acrylic esters and (b) Fluorine-containing (meth)acrylic esters), (c) styrene based compound, and (d) vinyl esters. The homopolymers thereof, copolymers two or more selected above, or the mixtures of the homopolymers and/or the copolymers can be used for the core region. Among them, the source material for the core region comprises desirably one or more (meth)acrylic ester.

More specifically, the examples include;
(a) (meth)acrylic esters such as methyl methacrylate, ethyl methacrylate, i-propyl methacrylate, t-butyl methacrylate, benzyl methacrylate, phenyl methacrylate, cyclohexyl methacrylate, di-phenyl methyl methacrylate, tricyclo [5·2·1·0^{2,6}] decanyl methacrylate, adamantyl methacrylate, i-bornyl methacrylate, methyl acrylate, ethyl acrylate, t-butyl acrylate and phenyl acrylate;
(b) Fluorine-containing methacrylic esters and acrylic esters such as 2,2,2-trifluoroetyl methacrylate, 2,2,3,3-tetrafluoropropyl methacrylate, 2,2,3,3,3-pentafluoropropyl methacrylate, 1-trifluoromethyl-2,2,2-trifluoroethyl methacrylate, 2,2,3,3,4,4,5,5-octafluoropenthyl methacrylate and 2,2,3,3,4,4-hexafluorobuthyl methacrylate;
(c) styrene based compounds such as styrene, α-methylstyrene, chloro styrene and bromo styrene; and
(d) vinyl esters such as vinyl acetate, vinyl benzoate, vinyl phenylacetate and vinyl chloroacetate.

As described above, polymerizable compounds another than (meth)acrylic esters may be used in the present invention. Examples of the another polymerizable compounds, which can be used in the present invention, but not specifically limited to, are shown bellow.

When the optical transmission medium is used for transmitting near infrared light, light loss is occurred due to the light absorption by the C—H bonds included in the polymer of the core region. In such cases, as described in Japanese patent No. 3332922, the polymers substituted with deuterium atoms at the positions of hydrogen atoms of C—H such as deuterated polymethyl methacrylate (PMMA-d8), poly-trifluoroisopropylethyl methacrylate (P3MA) and polyhexafluoroisopropyl 2-fluoroacrylate (HFIP 2-FA) are desirably used as material of the core, in order to shift the wavelength band in which the light loss due to the light absorption is occurred, to a longer wavelength band and reduce the light loss. The impurities and foreign materials potential scattering source included in the monomer are removed enough not to lower the transparency of the core region after polymerization.

One or more polymerization initiators and polymerization controllers exemplified above for the clad portion may be adde to the monomer when polymerization for the core region.

Introduction of distribution of the refractive index into the core region along the direction from the center to the outside thereof is preferable in terms of providing the plastic optical fiber of a distributed refractive index type having a high transmission capacity. The core region having a distributed refractive index can be formed mainly of (1) either a copolymer of two or more monomers or a mixture of two or more polymers, having different refractive indexes each other, and (2) a polymer matrix and an agent for adjusting refractive index (sometimes referred as “dopant” hereinafter).

When the core region is formed of (1), the monomers or polymers can be selected from the above exemplified monomers and polymers according to refractive indexes and reactivities thereof.

The refractive index adjusting agent is an agent such that a composition comprising the agent has a refractive index differing from, desirably higher than that of a composition without the agent. Specifically, the differences in the refractive indexes between the polymer matrix alone and the polymer matrix added the agent is not lower than 0.01. The agent can be included in the core region by adding a refractive index adjusting agent into the source materials for the core region before the polymerization, and carrying out the polymerization of the mixture. The refractive index adjusting agent is now defined as such that raising the refractive index of the polymer when being contained therein as compared with that of a polymer not containing such agent. Any compounds having the foregoing properties, being stably compatible with the polymer, not being polymerized with the polymerizable monomer, which is a source material, and being stable under polymerization conditions (heating, pressurizing, etc.) for the polymerizable monomer are available.

Examples of such available agent include benzyl benzoate (BEN), diphenyl sulfide (DPS), triphenyl phosphate (TPP), benzyl-n-butyl phthalate (BBP), diphenyl phthalate (DPP), biphenyl (DP), diphenylmethane (DPM), tricresyl phosphate (TCP), Diphenyl sulfoxide (DPSO), benzyl sulthylate, benzyl phenyl ether, benzoic anhydrayde, dibenzyl ether, diehtylene glycol dibenzoate, triphenylphosphate, diphenyl ether, diphenyl sulfide, m-phenoxy toluene, 1,2-propanediol dibenzoate, dibutyl phosphate, and diphenyl sulfoxide. Among them, BEN, DPS, TPP and DPSO are preferred. The examples of the agent include oligomers consisting of from 2 to 10 monomers. Tow or more species of the agents may be used.

By controlling concentration and distribution of the refractive index adjusting agent in the core region, the refractive index of the plastic optical fiber can be adjusted at a desired value. The amount of addition thereof may properly be selected typically depending on the applications or on source materials for the core region to be combined. It is to be noted that the refractive index-distributed structure can also be achieved by, in place of using the refractive index adjusting agent, using two or more species of polymerizable monomers for forming the core region and thus producing a distribution of co-polymerization ratio within the core region.

In the second step, it is preferred to carry out the polymerization under pressure (herein after referred as “pressurized polymerization”). In case of the pressurized polymerization, it is preferable to place the cylinder in the hollow space of a jig, and to carry out the polymerization while keeping the cylinder as being supported by the jig. While the pressurized polymerization is being carried out in a hollow portion of the structure corresponding to the clad region, the structure is kept as being inserted in the hollow space of the jig, and the jig prevents the shape of the structure from being deformed due to pressure. The jig is preferably shaped as having a hollow space in which the structure can be inserted, and the hollow space preferably has a profile similar to that of the structure. Since the structure corresponding to the clad region is formed in a cylindrical form in the present embodiment, it is preferable that also the jig has a cylindrical form. The jig can suppress deformation of the cylinder during the pressurized polymerization, and supports the cylinder so as to relax the shrinkage of the area corresponding to the core region with the progress of the pressurized polymerization. It is preferable that the jig has a hollow space having a diameter larger than the outer diameter of the cylinder corresponding to the clad region, and that the jig supports the cylinder corresponding to the clad region in a non-adhered manner. Since the jig has a cylindrical form in the present embodiment, the inner diameter of the jig is preferably larger by 0.1 to 40% than the outer diameter of the cylinder corresponding to the clad region, and more preferably larger by 10 to 20%.

The cylinder corresponding to the clad region can be placed in a polymerization vessel while being inserted in the hollow space of the jig. In the polymerization vessel, it is desirable that the cylinder is housed so as to vertically align the height-wise direction thereof. After the cylinder is placed, while being supported by the jig, in the polymerization vessel, the polymerization vessel is pressurized. The pressurizing of the polymerization vessel is preferably carried out using an inert gas such as nitrogen, and thus the pressurized polymerization preferably is carried out under an inert gas atmosphere. While a preferable range of the pressure during the polymerization may vary with species of the monomer, it is generally 0.02 to 10 MPa or around.

Preferred range of polymerization temperature and polymerization period may vary according to species of the polymerizable monomer, however, in general, the polymerization is preferably carried out at 90 to 140° C. for 24 to 96 hours.

A preform for the plastic optical member can be obtained through the first and second steps. The obtained preform may be subsequently or after being subjected to coating treatment, provided to a drawing process according to the present invention.

In the place of the second step or in carrying out the second step, as described in JP-A No. hei 5-181023 and No. hei 6-194530, polymerization for the core region may be carried out inside of a cylindrical clad under heating while adding dropwise a mixture of a polymerization initiator and a monomer capable of constituting a polymer of a core region having a refractive index differing from that of the clad region, into the cylindrical clad; as described in WO93/08488, polymerization of a mixture of a monomer, a polymerizable refractive index enhancer and polymerization initiator may be carried out in a cylindrical clad made of a polymer under heating, so as to create a distributed refractive index structure based on the concentration distribution of the enhances; and a method for varying continuously the monomer ratio of the polymer described in JP-A No. 4-97302 may be used.

As described in JP-A No. 2-16504, two or more species of polymerizable mixtures may be extruded concentrically to form a structure having numerous concentric layers thereof, in the place of carrying out the above process.

The process for producing a preform of a plastic optical fiber is described above, however, the process of the present invention is limited for this embodiment. The process according to the present invention can be applied a process for producing silica-based optical transmission mediums. In the present embodiment, the term of “optical fiber” is used for the obtained optical transmission medium, however, the diameter and length thereof are not limited. The process according to the present invention can be applied for producing optical transmission medium having various shapes.

In the present invention, the process for producing a preform used for a plastic optical fiber in which refractive index varies continuously from the core region to the clad region, namely GI-mode plastic optical fiber, is described above, however the process according to the present invention is not limited to a process for producing a GI-mode plastic optical fiber. The process according to the present invention can be applied for producing plastic optical fibers of single-mode, step indexes-mode and the like.

The plastic optical fiber after being processed in the drawing step according to the present invention can directly be subjected, without any modification, to various applications. The fiber may also be subjected to various applications in a form of having on the outer surface thereof a covering layer or fibrous layer, and/or in a form having a plurality of fibers bundled for the purpose of protection or reinforcement.

For the case where a coating is provided to the element wire, the covering process is such that running the element wire through a pair of opposing dies which has a through-hole for passing the element fiber, filling a molten polymer for the coating between the opposing dies, and moving the element fiber between the dies. The covering layer is preferably not fused with the element fiber in view of preventing the inner element fiber from being stressed by bending. In the covering process, the element fiber may be thermally damaged typically through contacting with the molten polymer. It is therefore preferable to set the moving speed of the element fiber so as to minimize the thermal damage, and to select a polymer for forming the covering layer which can be melted at a low temperature range. The thickness of the covering layer can be adjusted in consideration of fusing temperature of polymer for forming the covering layer, drawing speed of the element fiber, and cooling temperature of the covering layer.

Other known processes for forming the covering layer on the fiber include a method by which a monomer coated on the optical member is polymerized, a method of winding a sheet around, and a method of passing the optical member into a hollow pipe obtained by extrusion molding.

Coverage of the element fiber enables preparing of plastic optical fiber cable. Styles of the coverage include contact coverage in which plastic optical fiber is covered with a cover material so that the boundary of the both comes into close contact over the entire circumference; and loose coverage having a gap at the boundary of the cover material and plastic optical fiber. The contact coverage is generally preferable since the loose coverage tends to allow water to enter into the gap from the end of the cover layer when a part of the cover layer is peeled off typically at the coupling region with a connector, and to diffuse along the longitudinal direction thereof. The loose coverage in which the coverage and element fiber are not brought into close contact, however, is preferably used in some purposes since the cover layer can relieve most of damages such as stress or heat applied to the cable, and can thus reduce damages given on the element fiber. The diffusion of water from the end plane is avoidable by filling the gap with a fluid gel-form, semi-solid or powdery material. The coverage with higher performance will be obtained if the semi-solid or powdery material is provided with functions other than water diffusion preventive function, such as those improving heat resistance, mechanical properties and the like.

The loose coverage can be obtained by adjusting position of a head nipple of a crosshead die, and by controlling a decompression device so as to form the gap layer. The thickness of the gap layer can be adjusted by controlling the thickness of the nipple, or compressing/decompressing the gap layer.

It is further allowable to provide another cover layer (secondary cover layer) so as to surround the existing cover layer (primary cover layer). The secondary cover layer may be added with flame retarder, UV absorber, antioxidant, radical trapping agent, lubricant and so forth, which may be included also in the primary cover layer so far as a satisfactory level of the anti-moisture-permeability is ensured.

While there are known resins or additives containing bromine or other halogen or phosphorus as the flame retarder, those containing metal hydroxide are becoming a mainstream from the viewpoint of safety such as reduction in emission of toxic gas. The metal hydroxide has crystal water in the structure thereof and this makes it impossible to completely remove the adhered water in the production process, so that the flame-retardant coverage is preferably provided as an outer cover layer (secondary cover layer) surrounding the anti-moisture-permeability layer (primary cover layer) of the present invention.

It is still also allowable to stack cover layers having a plurality of functions. For example, besides flame retardation, it is allowable to provide a barrier layer for blocking moisture absorption by the element fiber or moisture absorbent for removing water, which are typified by hygroscopic tape or hygroscopic gel, within or between the cover layers. It is still also allowable to provide a flexible material layer for releasing stress under bending, a buffer material such as foaming layer, and a reinforcing layer for raising rigidity, all of which may be selected by purposes. Besides resin, a highly-elastic fiber (so-called tensile strength fiber) and/or a wire material such as highly-rigid metal wire are preferably added as a structural material to a thermoplastic resin, which reinforces the mechanical strength of the obtained cable.

Examples of the tensile strength fiber include aramid fiber, polyester fiber and polyamide fiber. Examples of the metal wire include stainless wire, zinc alloy wire and copper wire. Both of which are by no means limited to those described in the above. Any other protective armor such as metal tube, subsidiary wire for aerial cabling, and mechanisms for improving workability during wiring can be incorporated.

Types of the cable include collective cable having element fibers concentrically bundled; so-called tape conductor having element fibers linearly aligned therein; and collective cable further bundling them by press winding or wrapping sheath; all which can properly be selected depending on applications.

The cable may be formed of the optical fibers connected by butt joint, however, the cable is desirably formed of the optical fibers connected their terminals by the connectors so as to fix the connecting portion. The commercially available connectors such as PN type, SMA type, SMI type, F05 type, MU type, FC type or FC type connectors may be used.

The optical fiber or the optical fiber cable produced according to the present invention can be use in a system for transmitting light signal, which system comprises various light-emitting elements, light-receiving elements, optical switches, optical isolators, optical integrated circuits and optical transmission medium and receiver modules. If needed, other optical fibers may be used with them. Any known techniques may be applicable while making reference to “Purasuchikku Oputicaru Faiba no Kiso to Jissai (Basics and Practice of Plastic Optical Fiber)”, published by N.T.S. Co., Ltd.; and pages from 110 to 127 of “NIKKEI ELECTRONICS 2001. 12. vol. 3”. The plastic optical fiber produced according to the present invention may be combined with various techniques described in the above-mentioned literatures and may be used in various applications such as wirings in various digital apparatuses such as computers, vehicle and watercraft wirings, optical links between optical terminals and digital apparatuses, and optical transmitting systems which are capable of transmitting rapidly high-capacity data, or which are proper to transmitting light in short distance for controlling or the like without affect of electromagnetic wave, such as an indoor or intraregional optical LANs of houses, complex housings, factories, offices, hospitals, schools or the like.

The optical fiber produced according to the present invention, may be also combined with the techniques described in pages from 339 to 344 of “High-Uniformity Star Coupler Using Diffused Light Transmission” in IEICE TRANS. ELECTRON., VOL. E84-C, No. 3, March 2001 and pages from 476 to 480 of “Interconnection by optical sheet bus” in Journal of Japan Institute of Electronics Packaging, Vol. 3, No. 6, 2000; optical bus typically described in JP-A Nos. 10-123350, 2002-90571 and 2001-290055; optical branching/coupling device typically described in JP-A Nos. 2001-74971, 2000-329962, 2001-74966, 2001-74968, 2001-318263 and 2001-311840; optical star coupler typically described in JP-A No. 2000-241655; light signal transmission device and optical data bus system typically described in JP-A Nos. 2002-62457, 2002-101044 and 2001-305395; light signal processor typically described in JP-A No. 2002-23011; light signal cross-connection system typically described in JP-A No. 2001-86537; optical transmission system typically described in JP-A No. 2002-26815; multi-function system typically described in JP-A Nos. 2001-339554 and 2001-339555; various light guides, splitters, coupler or branching filters, so as to build up advanced optical transmitting systems including multiplexed two-way transmissions.

The optical transmission medium produced according to the present invention may be used in the technical field of lighting, transmitting energy, illumination, sensors or the like.

### EXAMPLES

The present invention will specifically be described referring to the specific examples. It is to be noted that any materials, reagents, ratio of use, operations and so forth can properly be altered without departing from the spirit of the present invention. The scope of the present invention is therefore by no means limited to the specific examples shown below.

### Example 1-1

600 weight parts of methyl methacrylate monomer purified by distillation so as to reduce the water content to as low as 0.008%, 1.4 weight parts of dewatered and purified benzoyl peroxide as a polymerization initiator, and 1.6 weight parts of n-butylmercaptan as a polymerization controller (chain transfer agent) were individually weighed in separate glass containers, combined, and then mixed and dissolved with stirring in a dark environment, to thereby obtain a source material solution. A part of the source material solution was poured into a cylindrical test tube made of PTFE (polytetrafluoroethylene) and has an inner diameter of 25 mm and a length of 1,000 mm. The test tube was sealed, and the content was allowed to react under shaking in a water bath at 70° C. for 2 hours. Next, the test tube was kept horizontally in a hot-air thermostatic chamber, and rotated at 3,000 rpm in a protective tube so as to allow the content to be pressed by centrifugal force to the inner wall of the test tube, and to polymerize for 2 hours, to thereby obtain a cylindrical hollow tube composed of PMMA, which was intended for use as a cladding tube.

The cladding tube was taken out from the test tube and kept at 90° C. 700 weight parts of methyl methacrylate monomer purified by distillation so as to reduce the water content to as low as 0.008%, 0.01 weight parts of dewatered and purified di-tert-butyl peroxide as a polymerization initiator, 0.3 weight parts of laurylmercaptan as a polymerization regulator (chain transfer agent), and a solution of 10 wt % of diphenyl sulfide with respect to MMA as a refractive index adjustor for producing a graded index core portion were individually weighed in separate glass containers, combined, and then mixed and dissolved with stirring in a dark environment, to thereby obtain a source material solution. The source material solution was filtered through a PTFE membrane filter having a pore size of 0.2 micrometers, and the filtrate was poured into the hollow portion of the cladding tube kept at 90° C. The mixture was allowed to react in a nitrogen atmosphere at 120° C. for 50 hours under a pressure of 0.1 MPa, so as to form the core portion. A preform having a diameter of 22 mm and a length of 800 mm was thus obtained. The preform was found to have a distribution pattern of refractive index of 2.8 by square approximation when measured using an index profiler produced by Seiko EG&G Co., Ltd.

Thus produced preform was drawn into fiber as described below using a drawing apparatus configured similarly to as illustrated in FIG. 1.

The preform 9 was fixed in a hanging style to a preform hanging fixture 8 of the drawing apparatus, and the front end of the preform 9 was introduced into the cylindrical heating furnace 10. The heating furnace 10 has an inner diameter of 60 mm and a height of 250 mm, where on the upper stage of the internal portion thereof, an electric heater (not shown) having a height of 50 mm and a maximum output of 500 W is disposed, and the lower 200-mm portion is configured as a cylindrical chamber 10′ for irradiating laser light from the carbon dioxide gas laser generator 11, and lined with a heat-resistant bricks. The electric heater portion was heated to 50° C. At the upper opening portion of the electric heater, a stop having a diameter of aperture of 35 mm was disposed in order to suppress heat loss during the drawing. The carbon dioxide gas laser generator 11 (1 unit) having an irradiation wavelength of 10.6 micrometers and maximum output of 60 W was set so that the laser light is irradiated to the preform 9 at an incident angle of 45° in the chamber 10′ below the electric heater. The laser light (45 W) from the carbon dioxide gas laser generator 11 was split into four beams using an optical system 13, and was irradiated to the preform 9 from four directions. The irradiation area by the carbon oxide gas laser after collimation was adjusted to 45 mm in diameter.

Fiber making could be started from the preform when the front end of the preform was melted and began to run down. The front end portion was further drawn so as to make fiber, and set on the pulling rolls for pulling. Then the pulling of the fiber 10′ was started, and concomitantly the preform hanging fixture 8 was automatically allowed to descend so as to gradually feed the preform into the heating furnace 10. The descending speed was determined by a preliminary drawing. Diameter of the drawn fiber 9′ was measured using a laser measuring gauge 14b, and was computer-controlled so as to keep a constant value. The fiber 9′ immediately after the drawing was cooled by air blow at 15° C. using a cooling fan 20.

The drawing was started at a pulling speed of 2 m/min, then the pulling speed given by the pulling rolls 15 was gradually increased by 1 m/min while observing the status of the starting position of the drawing of the preform 9, and the drawing was finally proceeded at a pulling speed of 12 m/min so as to produce the optical fiber having an outer diameter of 750 micrometers.

Temperature of the preform immediately before the laser irradiation was found to be 50° C. when measured using a non-contact thermometer, and that immediately after the laser irradiation was found to be 260° C. when measured similarly. Energy consumed in the heating of the preform was estimated as 10 W or above based on the shape and physical properties of the preform. Energy efficiency of the heating was found to be 20% or above.

The starting position “a” of the drawing of the preform was almost kept constant without being shifted upward or downward even at a pulling speed of 12 m/min, and tension of pulling was also found to be stable at around 120 g.

The drawn optical fiber 9′ was automatically taken up by a take-up reel (not shown) having a diameter of 400 mm placed immediately after the pulling rolls 15. The take-up reel has a take-up portion of 200 mm wide, and the fiber 9′ was uniformly taken up over the entire width of 200 mm while being slowly slid in the direction of the reel axis in a reciprocating manner using an automatic traversing device.

The wound optical fiber was withdrawn from the reel 24 hours after for observation, and showed an excellent shape but no winding habit. Transmission loss at 650 nm of the resultant optical fiber was found to be 168 dB/km, and the band characteristic, an index for information volume which can simultaneously be transmitted through a fiber, was found to be as wide as 1.9 GB/sec·100 m. Variation in the diameter was found to be 750 micrometers±20 micrometers.

### Example 1-2

Using a preform produced similarly to as described in Example 1-1, the drawing was carried out under the conditions similar to those in Example 1, except that output of the carbon dioxide gas laser was reduced to 35 W, the laser light is irradiated only from a single direction without being split by the optical system, and instead the preform is rotated at 12 rpm so as to ensure uniform heating.

The drawing could finally be proceeded at a pulling speed of 16 m/min so as to produce the optical fiber having an outer diameter of 750 micrometers, where shape of the fiber and distribution of the refractive index were desirable similarly to those in Example 1-1. Transmission loss at 650 nm of the resultant optical fiber was found to be 165 dB/km. The band characteristic was also found to be desirable, showing a value of 1.9 GB/sec·100 m.

### Example 1-3

Using a preform having a diameter of 29 mm produced similarly to as described in Example 1-1, the drawing was carried out under the conditions similar to those in Example 1, except that output of the carbon dioxide gas laser was raised to 50 W, the laser light is irradiated only from a single direction without being split by the optical system, and instead the preform is rotated at 20 rpm so as to ensure uniform heating.

The drawing could finally be proceeded at a pulling speed of 12 m/min so as to produce the optical fiber having an outer diameter of 750 micrometers, where shape of the fiber and distribution of the refractive index were desirable similarly to those in Example 1-1. Transmission loss at 650 nm of the resultant optical fiber was found to be 175 dB/km. The band characteristic was also found to be desirable, showing a value of 1.8 GB/sec·100 m.

### Example 1-4

Using a preform produced similarly to as described in Example 1-1, the drawing was carried out under the conditions similar to those in Example 1, except that two units of 30-W laser generators were used, the individual laser lights were split into two beams, and total four beams were then irradiated from four directions surrounding the preform.

The drawing could finally be proceeded at a pulling speed of 15 m/min, where shape of the fiber and distribution of the refractive index were desirable similarly to those in Example 1-1. Transmission loss at 650 nm of the resultant optical fiber was found to be 166 dB/km. The band characteristic was 1.9 GB/sec·100 m.

### Example 1-5

Using a preform produced similarly to as described in Example 1-1, the drawing was carried out under the conditions similar to those in Example 1, except that the laser light was irradiated in a laser irradiation area of which diameter was enlarged up to 70 mm (DL=70 mm and DP=22 mm, which represent an Example for DL>2.5×DP).

The final drawing speed decreased to as low as 9 m/min, but the drawing was still allowable. The shape of the fiber and distribution of the refractive index were degraded as compared with those in Example 1-1. The heat-resistant lining on the inner wall of the furnace showed damage due to heat deformation, which was possibly ascribable to local and abrupt heating of the inner wall by the laser light not landed on the preform. Transmission loss at 650 nm of the resultant optical fiber was found to be 281 dB/km. The band characteristic was found to be 0.6 GB/sec·100 m.

### Example 1-6

The drawing was carried out under the conditions similar to those in Example 1, except that the output of the laser light for heating was regulated by feed-back control based on the output of the laser measuring gauge 14b. Transmission loss at 650 nm of the resultant optical fiber was found to be 151 dB/km, and the band characteristic, an index for information volume which can simultaneously be transmitted through a fiber, was found to be desirable, showing a value of as wide as 2.2 GB/sec·100 m. Variation in the diameter was found to be improved, showing a range of 750 micrometers±4 micrometers.

### Comparative Example 1-1

Five units of the cylindrical electric heaters having the maximum output of 500 W, such as those used in Example 1-1, were used in a stacked manner, whereas the carbon dioxide gas laser used in Example 1-1 was abandoned. The heaters were individually heated to 220° C. At the upper opening portion of the electric heater, a stop having a diameter of aperture of 35 mm was disposed in order to suppress heat loss during the drawing. Using this apparatus, the preform was drawn according to the procedures same as those in the Examples.

Because the drawing start position of the preform began to slowly descend and the drawing tension began to increase beyond 250 g when the pulling speed reached 5 m/min, the drawing was terminated. The drawn optical fiber was taken up on the 400-mm reel similarly to as described in Example 1-1, and was withdrawn from the reel 24 hours after. Winding habit and skew were observed over the entire length of the optical fiber from the point taken up at 2 m/min to a point taken up at 4.5 m/min. A duration of time required for obtaining the same length of fiber as in Example 1-1 was prolonged by three times or more. Transmission loss at 650 nm of the resultant optical fiber taken up at 4.5 m/min was found to be 399 dB/km, and the band characteristic was found to be only as small as 0.4 GB/sec·100 m.

### Comparative Example 1-2

The drawing was carried out under the conditions similar to those in Comparative Example 1-1, except that the output of the heating furnace was regulated by feed-back control based on the output of the laser measuring gauge. Because the output control could not catch up with the drawing speed, the preform could not uniformly be drawn, and the resultant optical fiber showed degraded values for all characteristics, showing a transmission loss at 650 nm of 411 dB/km, a band characteristic of 0.4 GB/sec·100 m, and variation in the fiber diameter of 750 micrometers±40 micrometers.

### Example 2-1

600 weight parts of methyl methacrylate monomer purified by distillation so as to reduce the water content to as low as 0.008%, 1.4 weight parts of dewatered and purified benzoyl peroxide as a polymerization initiator, and 1.6 weight parts of n-butylmercaptan as a polymerization regulator (chain transfer agent) were individually weighed in separate glass containers, combined, and then mixed and dissolved with stirring in a dark environment, to thereby obtain a source material solution. The source material solution was poured into a cylindrical test tube made of PTFE (polytetrafluoroethylene) and has an inner diameter of 30 mm and a length of 1,000 mm. The test tube was sealed, and the content was allowed to react under shaking in a water bath at 70° C. for 2 hours. Next, the test tube was kept horizontally in a hot-air thermostatic chamber, and rotated at 3,000 rpm in a protective tube so as to allow the content to be pressed by centrifugal force to the inner wall of the test tube, and to polymerize for 2 hours, to thereby obtain a cylindrical hollow tube composed of PMMA, which was intended for use as a cladding tube.

The cladding tube was taken out from the test tube and kept at 90° C. 700 weight parts of methyl methacrylate monomer purified by distillation so as to reduce the water content to as low as 0.008%, 0.01 weight parts of dewatered and purified di-tert-butyl peroxide as a polymerization initiator, 0.3 weight parts of laurylmercaptan as a polymerization regulator (chain transfer agent), and a solution of 10 wt % diphenyl sulfide with respect to MMA as a refractive index adjustor for producing a graded index core portion were individually weighed in separate glass containers, combined, and then mixed and dissolved with stirring in a dark environment, to thereby obtain a source material solution. The source material solution was filtered through a PTFE membrane filter having a pore size of 0.2 micrometers, and the filtrate was poured into the hollow portion of the cladding tube kept at 90° C. The mixture was allowed to react in a nitrogen atmosphere at 120° C. for 50 hours under a pressure of 0.1 MPa, so as to form the core portion. A preform having a diameter of 29 mm and a length of 800 mm was thus obtained.

The preform was found to have a distribution pattern of refractive index of 2.6 by square approximation when measured using an index profiler produced by Seiko EG&G Co., Ltd.

Thus produced preform was drawn using a drawing apparatus configured similarly to as illustrated in FIG. 1 except that a heater having an inner diameter of 40 mm and a height of 500 mm comprised two compartments, where the upper compartment was heated to 200° C., and the lower to 140° C. is used in the place of the laser generator for heating and softening the preform; and an arm having a rotating device for rotating the preform round an axis in the longitudinal direction of the preform at 0.1 turns/sec during drawing.

To describe more specifically, the obtained preform was fixed in a hanging style to a preform hanging fixture 8 of the arm 1, and was rotated using a rotating device (not shown) around an axis in the longitudinal direction of the preform at 0.1 turns/sec. The arm 1 was then descended by the screw driver so as to insert the front end of the preform into the warmed-up cylindrical heater (not shown, similar to heater 10). The heater having an inner diameter of 40 mm and a height of 500 mm comprised two compartments, where the upper compartment was heated to 200° C., and the lower to 140° C. The preform was heated and softened in two compartments. The front end of the softened preform was then drawn out from the bottom portion of the heater at a pulling speed of 3 m/min by the pulling rolls 15. At the upper opening portion of the heater, a stop having a diameter of aperture of 35 mm was disposed in order to suppress heat loss during the drawing. Then the pulling by the pulling rolls 15 was started, and concomitantly the arm 1 was automatically descended at a constant speed so as to gradually feed the preform into the heater. The descending speed was determined by a preliminary drawing. Diameter of the pulled fiber was measured using a laser measuring gauge (not shown), and the pulling force was controlled so as to keep the diameter constant.

In this drawing, Lᵣ (displacement per unit time on the circumference as contributed by the rotation) shown in FIG. 3A was 9.1 mm/sec, and L_{d} (displacement per unit time in the longitudinal direction as contributed by the drawing) was 50 mm/sec. The calculation of Lᵣ herein was based on a diameter “R” of the preform, which was an average of values measured at three arbitrary points on the circumference using calipers. Variation in the diameter over 1 m of thus-drawn fiber was 750 micrometers±15 micrometers, and was found to be uniform. Transmission loss at 650 nm was measured as 158 dB/km.

Thus-obtained optical fiber was further subjected to measurements of tensile strength, knot strength and shrinkage factor according to the processes described below.

(Method of Measuring Tensile Strength)

The measurement of tensile strength was carried out conforming to JIS C6861-1999. The test environment was defined as standard conditions specified in JIS C0010 (temperature: 15° C. to 35° C., relative humidity: 25% to 85%, atmospheric pressure: 86 kPa to 106 kPa). An exemplary available test instrument can be “Tensilon Universal Tester” produced by Orientec Corporation. A sample used herein was a fiber of 120 mm to 130 mm long, and was attached to chucks of the test instrument. The chucks used herein were air chucks which can pneumatically open or close so as to prevent the sample fiber from breaking at the chuck portions during the measurement. The sample fiber was stretched until it broke while setting a tensile length (length between the chucks) to 100 mm and a tensile speed to 10 mm/min. Load applied to the sample fiber was measured using a load cell, measured values of the load were plotted against distortion (elongation) to thereby obtain a relation between the load and distortion (elongation), and based on this plot a value of yield strength was estimated. The tensile strength herein expressed in terms of yield strength was 93 MPa.

(Method of Measuring Knot Strength)

The measurement of knot strength was carried out using “Tensilon Universal Tester”, a tensile tester produced by Orientec Corporation. A sample used herein was a fiber of 100 mm length. The chucks used herein were air chucks which can pneumatically open or close so as to prevent the sample fiber from breaking at the chuck portions during the measurement. The tensile length (length between the chucks) was set to 50 mm, and the sample fiber was fixed by clamping it in a 12.5-mm-length portion on the upper end thereof using an upper chuck. A loose knot was made in the fiber, and the sample fiber was then fixed by clamping it in a 12.5-mm-length portion on the lower end thereof using a lower chuck. The sample fiber was then stretched until it broke while setting a tensile speed to 10 mm/min. Load applied to the sample fiber was measured using a load cell, measured values of the load were plotted against distortion (elongation) to thereby obtain a relation between the load and distortion (elongation), and based on this plot a value of load which caused breakage of the sample fiber was obtained as a value of knot strength. The knot strength was measured as 65 MPa.

(Method of Measuring Shrinkage Factor—Weatherability Test—)

In a weatherability tester (Temperature and Humidity Chamber PR-2SP, produced by TABEI ESPEC Corp.) conditioned at 70° C. and 40% RH, thus obtained plastic optical fiber of 1 m-length was allowed to stand for 48 hours without being applied with tension, and lengths of the fiber were compared before and after the weatherability test. The shrinkage factor in the longitudinal direction was found to be 1.2%.

In the example 2-1, the preform was heated by the heater, however, the preform may be heated by irradiation of a laser in the same manner as example 1-1. And in such an example, the prepared fiber may have both of effects brought about by heating the preform with irradiation of laser and by rotating the preform during drawing.

### Comparative Example 2-1

The preform was drawn and the plastic optical fiber was obtained similarly to as described in Example 2-1, except that the rotating device was not activated.

The obtained optical fiber was subjected to measurements of tensile strength, knot strength and shrinkage factor. The tensile strength expressed by yield strength was 95 MPa, but knot strength was found to be 37 MPa, which was considerably lowered as compared with that of the fiber in Example 2-1. The shrinkage factor was 2.8, which indicated a considerable increase in the shrinkage factor in the longitudinal direction as compared with the fiber in Example 2-1. Transmission loss at 650 nm of the resultant optical fiber was found to be 172 dB/km. Variation in the diameter over 1 m of the fiber was as large as 750 micrometers±35 micrometers, despite it was controlled similarly to as described in Example 2-1.

Although the graded-index plastic optical fiber was used in the present invention, it is fairly easy to adopt the present invention to drawing of SI (step-index) plastic optical fiber or multi-step S1 plastic optical fiber.

### INDUSTRIAL APPLICABILITY

The present invention can provide a process and an apparatus for producing an optical transmission medium capable of producing an optical transmission medium having desirable properties in a stable and highly-productive manner.

The present invention can also provide a plastic optical transmission medium having a large strength, excellent handling property during laying, and moderated anisotropy of the stretching property, and a process of producing such plastic optical transmission medium. The present invention can still also provide a process of producing an optical transmission medium capable of reducing variation in the diameter of the obtained fiber, and ensuring excellent producing stability.

1. A process for producing an optical transmission medium comprising a drawing step of drawing a molten portion of a preform of the optical transmission medium to form the optical transmission medium, wherein, during the drawing step, the preform is heated by irradiation with laser light thereby being partially molten.

2. The process of claim 1, wherein said preform is formed of a plastic, and said laser light has a wavelength of 0.7 to 20.0 micrometers.

3. The process of claim 1, wherein in the drawing step, at least output of the laser light is controlled to thereby adjust the diameter of the optical transmission medium.

4. The process of claim 1, wherein irradiation energy efficiency of the laser light is 1% or above.

5. The process of claim 1, wherein the laser is a carbon dioxide gas laser.

6. The process of claim 1, wherein, in the drawing step, the diameter DL of the area irradiated by said laser light satisfies the relational formula (1) below:
DL≦2.5×DP (1)
where DP (mm) is the outermost diameter of a section in a plane normal to the longitudinal direction of said preform.

7. The process of claim 1, further comprising before said drawing step, a preheating step of preheating said preform using a heat source other than the laser heat source to a temperature lower than the glass transition point thereof.

8. The process of claim 1, wherein said preform has a distribution in the refractive index.

9. The process of claim 1, wherein the preform is rotated in a fixed direction during the drawing step.

10. The process of claim 9, wherein, in said drawing step, said preform is rotated around an axis nearly in parallel to the axis of drawing.

11. The process of claim 9, wherein, in said drawing step, a value of (Lᵣ/L_{d}) falls within a range from 0.01 to 95, where L_{d} represents a maximum displacement per unit time of an arbitrary point on the surface of said preform caused in the drawing direction produced by drawing, and Lᵣ represents displacement per unit time thereof caused in the direction normal to said drawing direction produced by rotation.

12. The process of claim 9, wherein, in said drawing step, the angle of drawing falls within a range from 5° to 85°.

13. An apparatus for producing an optical transmission medium comprising a heating means for heating and melting partially a preform of the optical transmission medium by irradiation with laser light, and a drawing means for drawing a molten portion of the preform.

14. The apparatus of claim 13, further comprising a control means for detecting the diameter of the drawn preform, and controlling at least output of said laser light based on the detected value.

15. The apparatus of claim 13, wherein said heating means is a means for heating and melting partially said preform by irradiation with the laser light in an irradiation area having a diameter DL(mm) which satisfies the relational formula (1) below:
DL≦2.5×DP (1)
where, DP (mm) is the outermost diameter of a section in a plane normal to the longitudinal direction of said preform.

16. The apparatus of claim 13, further comprising a preheating means for heating said preform to a temperature lower than the glass transition point thereof before said preform is heated and melted partially by said heating means.

17. The apparatus of claim 13, wherein said preheating means is a means for heating said preform by allowing it to pass through a chamber conditioned at a temperature lower than the glass transition point of said preform.

18. The apparatus of claim 13, wherein said heating means is capable of heating said preform at an energy efficiency of 1% or above.

19. The apparatus of claim 13, wherein said drawing means is a means for drawing said preform into a fiber form by producing difference between a speed at which said preform is sent downward and a speed at which said preform is pulled downward.

20. The apparatus of claim 14, wherein said drawing means is a means for drawing said preform into a fiber form by producing difference between a speed v₁ at which said preform is sent downward and a speed v₂ at which said preform is pulled downward, and said control means is a means for further controlling v₁ and/or v₂ based on said detected value.

21. The apparatus of claim 13, further comprising a rotary support means for supporting said preform during drawing while keeping said preform rotated.

22. A plastic optical transmission medium formed of a plastic wherein molecules of the plastic are oriented in a certain direction not in parallel to the longitudinal direction of said plastic optical transmission medium.

23. The plastic optical transmission medium of claim 22, wherein molecules of the plastic are spirally oriented around an axis which is nearly in parallel to the longitudinal direction of said plastic optical transmission medium.

24. The plastic optical transmission medium of claim 22, wherein molecules of said plastic oriented as being inclined by 5° to 85° away from the longitudinal direction of said plastic optical transmission medium.

25. The plastic optical transmission medium of claim 22, having a shrinkage factor of 2% or less when measured in a weatherability test conducted at 70° C. and 40% RH for 48 hours.

26. The plastic optical transmission medium of claim 22, having a knot strength of 50 MPa or above.
